(19) United States
(12) Patent Application Publication
(10) Pub. No.: US 2024/0251925 A1
(43) Pub. Date: Aug. 1, 2024

(54) AUTOMATED NAIL SERVICE SYSTEM

(71) Applicant: Elementree Inc., San Francisco, CA (US)

(72) Inventors: Renuka Ajay Apte, San Francisco, CA (US); Aaron James Feldstein, San Francisco, CA (US); Erik Oscar Sunden, San Francisco, CA (US); Christopher Sean Masterson, San Francisco, CA (US)

(21) Appl. No.: 18/430,541

(22) Filed: Feb. 1, 2024

Related U.S. Application Data
(60) Provisional application No. 63/442,559, filed on Feb. 1, 2023.

(51) Int. Cl. A45D 29/00; B08B 1/16

(52) U.S. Cl. CPC A45D 29/007; B08B 1/165

(57) ABSTRACT

The present disclosure relates to automated systems for nail services, including blotting, nail polish removal, nail polish storage and display, etc. In some embodiments, the systems work in conjunction with or are part of a robotic apparatus for automatic nail polish application or removal on natural or artificial finger or toenails.

### RELATED APPLICATION

This application claims priority to U.S. Provisional application No. 63/442,559 filed on Feb. 1, 2023 which is incorporated by reference herein in its entirety.

### FIELD

The present disclosure relates to systems and methods for automated services, and more particularly for automated treatment of a portion of the body of a user, such as the hands or the feet of the user.

### BACKGROUND

Conventionally, painting nails involves using a brush with flexible bristles that is dipped into a bottle of nail polish and used to paint natural or artificial nails. It involves a high degree of precision and accuracy on the part of a human to apply a smooth coat of nail polish on nails while staying within the boundaries of the nail. The high degree of precision and accuracy required has posed a challenge to mechanizing the painting of nails. Conventional robotic methods have been unable to replicate the accurate and smooth coats of nail polish achievable by humans. In addition, achieving a complete mechanized system that includes one or more of blotting and removal of blots, storage and placement of nail polish containers, and removal of polish has not been feasible.

### SUMMARY

The present disclosure relates to a robotic apparatus and methods for automatic nail polish application on natural or artificial finger or toe nails. In some embodiments, the robot uses artificial intelligence (AI) to identify and paints the nails. The robot uses depth sensors and computer vision to plan the movements of an end-effector. In one embodiment, the robot uses AI and machine learning techniques such as deep reinforcement learning, and other algorithms and calculations to plan its path. An AI controller can be trained using AI libraries. In conjunction with the robotic apparatus, there may be one or more additional nail services that include blotting of polish, polish storage for the apparatus, and polish removal from the nails.

In one embodiment, an autoblotter may provide a blotting function. The autoblotter may include a blotting surface or test area designed to receive a discharge of dispensed nail polish from a robotic dispenser.

In one embodiment, the autoblotter may include a platform located adjacent to a dispenser, such as a robotic dispenser that is configured for dispensing nail polish. The autoblotter may have an automated blotting surface positioned on the platform, where the blotting surface is designed to receive a discharge of dispensed nail polish from the robotic dispenser. This allows the robotic dispenser to blot polish on the tip of the dispenser, such as before depositing it on the nail.

In one embodiment, an autoblotter may include: a blotting surface that is movable. For example, the blotting service may be rotatable around a central axis. The surface may be configured to collect nail polish dispensed thereto. A scraper adjacent to the blotting surface may remove nail polish on the blotting surface (such as by scraping it off the surface). A waste channel conduit adjacent to the scraper may collect nail polish scraped off by the scraper and may direct the scraped nail polish to a waste collection area.

In one embodiment, an automated method of cleaning a blotting surface of an autoblotter may include identifying when an area of the blotting surface contains nail polish and engaging the area of the blotting surface with a cleaning tool to remove the nail polish.

The nail services may also include nail polish removal. In one embodiment, a nail polish remover system may include: a stationary base; a nail polish remover container (or pot) positioned within the stationary base, wherein the nail polish remover container is configured to contain a material for assisting in the removal of nail polish; and a rotating container holder (or rotating pot holder) that is rotatably positioned on the stationary base for securing the nail polish remover container to the stationary base and rotating the nail polish remover container during use.

The nail services may further include a nail polish storage container for storing nail polish before it is dispensed to the nail. In one embodiment, the nail polish storage container is a cartridge that may include: a reservoir or chamber for holding nail polish; a nozzle or tip coupled to the reservoir for dispensing the nail polish; a removable sealing cap for sealing the nozzle or tip; and an electronic storage device.

In one embodiment, a cartridge may include: a body having a first end, a second end, and a chamber formed between the first end and the second end for containing nail polish; a tip coupled to the first end of body and configured to direct flow of nail polish onto a nail surface; a rear seal coupled to the second end of the body to provide sealing thereto; and a removable sealing cap having an open end and a closed end, the removable sealing cap for covering the tip to close the tip of the cartridge, the sealing cap having one or more support pins adjacent the open end.

The nail services may include a mechanism for storing and/or displaying cartridges prior to or during nail polish dispensing onto a nail. In one embodiment, a cartridge dispenser may include: a display area for displaying cartridges; an inclined feed rail adjacent the display area for holding the cartridges arranged along the inclined feed rail, each cartridge comprising a sealing cap; a pair of vertical guide slots coupled to the feed rail for controlling an orientation and path of the cartridges as they descend from the feed rail into the display area, the sealing cap of each cartridge resting on the vertical guide slots to hold the cartridge on the inclined feed rail; and a discard ramp positioned below the display area for collecting sealing caps removed from the cartridges, wherein, when a cartridge is pulled out from the display area, the sealing cap of the cartridge rotates away from the display area and falls onto the discard ramp.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an illustration of a robotic apparatus in accordance with an embodiment.

FIGS. 2A-B illustrate different views of the robotic apparatus of FIG. 1.

FIGS. 3A-D illustrate an autoblotter in accordance with an embodiment.

FIGS. 4A-B illustrate an automatic nail polish remover system in accordance with an embodiment.

FIGS. 5A-B illustrate a nail polish remover container in accordance with an embodiment.

FIGS. 6A-D illustrate a cartridge in accordance with an embodiment.

FIGS. 7A-C illustrate a cartridge dispenser in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments are described below. It is, however, expressly noted that the present subject matter is not limited to these embodiments, but rather the intention is that variations, modifications, and equivalents that are apparent to the person skilled in the art are also included.

### Overview

The present disclosure relates to automated services or automated treatment of a portion of the body of a user, such as the hands or the feet of the user. Some embodiments relate to services associated with nails of the user (e.g., fingernails and/or toenails). Some embodiments include services related to automated delivery of nail polish onto nails, automated removal of nail polish, automated preparation/priming and blotting of nail polish cartridge to prepare for painting the nails or cleaning up after painting, or other activities related to nails. In one example, the disclosure relates to a robotic apparatus for automatic nail polish application, such as nail polish application or removal.

In some embodiments, the system includes various components or subsystems, such as an autoblotter, a nail polish remover system, a cartridge and a cartridge dispenser. Each of the subsystems are described in more detail below.

Any or all of these subsystems can be used as standalone systems or can be used as subcomponents within another system. For example, where the system is an automated hand or nail treatment system, the subsystems can be subcomponents of this larger system. In embodiments where the system is a robotic apparatus for providing nail polish and other materials onto nails, or removing nail polish or other materials, the subsystems may be components of the robotic apparatus. In this example, one or more of the subsystems may be partially or fully contained in a housing for the robotic apparatus. Thus, a user can place his or her hand into or onto a portion of the housing for automatically receiving nail treatments or services by the robotic apparatus, including use of the subsystems to provide the services. Some of the subsystems may be separate from or outside of the housing of the robotic apparatus, and may be used before the user places his or her hand into the robotic apparatus for nail polishing services.

Throughout the disclosure, the delivery and removal of nail polish or other materials or treatment of a user's nails (fingernails or toenails) is used as an example for illustration. However, other types of services are also possible, including providing artificial nails, providing nail decals or nail patterns/nail art, providing gel or powder nail services, UV curing of nail polish, drying of nails, shaping of nails or cuticles, buffing of nails, foot or hand cleansing or soaking, massaging of a user's hands or feet, a paraffin wax treatment on hands, feet, arms, etc., delivering a henna pattern onto the user's hand, arm, other body parts, among other treatments. In addition, a robotic apparatus for automated delivery of treatments (e.g., a nail painting robot) is used as an example throughout, though the system may take other forms, as well. To illustrate the robotic apparatus example, an overview of a possible robotic apparatus and method is provided below for use with the subsystems that are described in the section that follows this overview. However, the robotic apparatus and method may also take other forms or involve different components or steps than those provided in the overview.

### System Overview

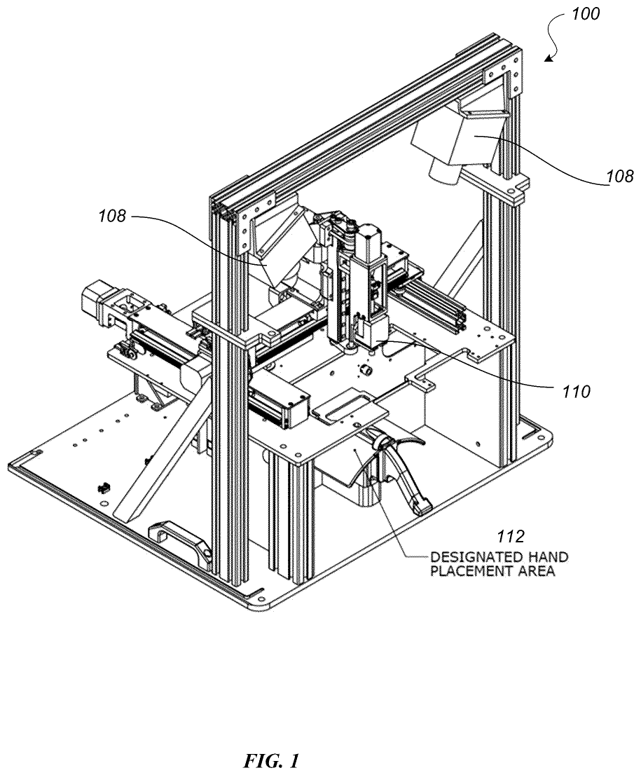

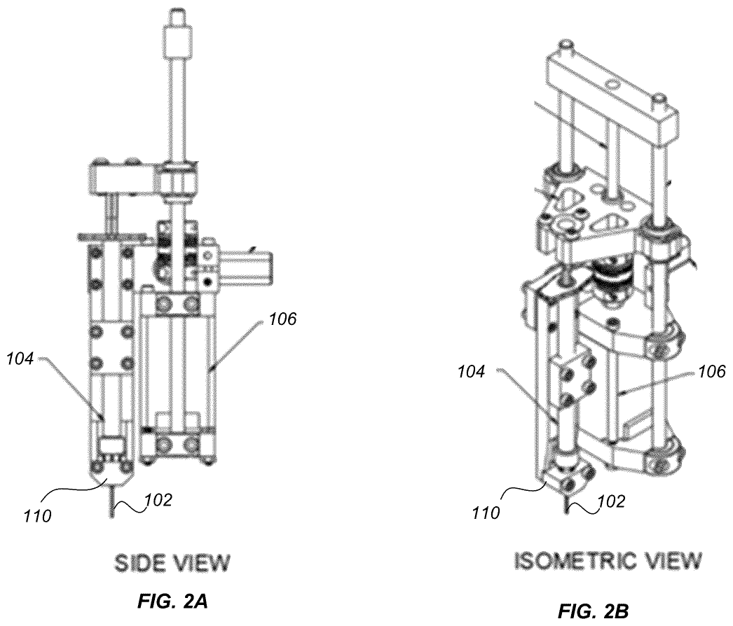

As shown in FIGS. 1, 2A and 2B, the system 100 includes a robotic apparatus 110, according to some embodiments. The components of the robotic apparatus may include an end effector 102 that may be a dispenser for dispensing, from a cartridge 104, nail polish or other materials onto the nails of a user at a controlled rate. A motor 106 moves the end-effector or dispenser around to deposit the nail polish. The dispenser can move or slide along one or more tracks or rails or can otherwise translate such that it can move at least in an X, Y, and Z direction (side-to-side, back-and-forth, up-and-down), allowing it to cover the entire surface of each nail. Other mechanisms of movement of the dispenser can also be used that require no tracks or fewer tracks. In some embodiments, the robot uses artificial intelligence (AI) to identify and paint the nails. In these embodiments, the robot may use depth sensors and computer vision to plan the movements of an device for delivering the nail polish or performing other services. In one embodiment, the robot uses AI and machine learning techniques, such as deep reinforcement learning, and other algorithms and calculations to plan its path. An AI controller can be trained using OpenAI's Gym or DeepMind's TRFL libraries.

One or more sensors, e.g., cameras, LIDAR, laser triangulation, time of flight sensors, pressure or touch sensors, etc., may capture input to be used to control the operation of the apparatus. As shown in FIG. 1, sensors 108 may be located at the top corners of the device and pointed toward the handrest (or designated hand placement area) 112 and end effector tip for capturing images. In one embodiment, the sensors are used to locate the user's hands or feet and ensure the user's hand or feet are properly positioned in the designated region. In one embodiment, the sensor identifies the nail based on machine learning, e.g., by using training data that identifies nails from many different users. Once the nail is identified, input from the sensors is used by the robot to determine the depth and location of the user's nails, particularly for operation of the motion of the robot and determining whether it is safe for the robot to continue operation.

In some embodiments, the robot creates a representation of the location of the user's nails using sensors. The representation may be created by a representation module in the software that controls the robot. The software and/or processor may be stored/positioned in the robot, near the robot or may be remote from the robot, e.g., across the room or far from the robot using cloud computing. In one embodiment, the robot uses a depth sensing camera that uses binocular vision and/or structured light for depth sensing and produces the representation in 3D spatial coordinates. In one embodiment, the robot uses the camera(s) and software, e.g., machine learning or artificial intelligence software, to identify nails and determine what parts of the camera frame correspond to the parts that need to be painted. An embodiment of an AI to detect nails could be a convolutional neural network based on image segmentation models from the Facebook Detectron or TensorFlow model zoos, and could be trained on human labeled images.

The representation of the user's nails may be an input to a motion planner. The motion planner is a software component that controls the motion of the robot, e.g., the motion of the motion platform, end effector, and/or cartridge. In some embodiments, the motion planner uses a combination of deep reinforcement learning, mathematical transformations, computer vision, and AI to plan the path that the motion platform must take to accomplish the goal of painting the nails. The motion planner is a real-time component, meaning it can adjust the planned path as it performs its operations and senses the environment. The motion planner may use a calibration created at run-time or in the factory to convert camera positions into coordinates that can be used by the motion platform. The robot paints the nails in accordance with the selected type of nail treatment. Determining the motion of the hands or nails can be determined by determining a first position of the hand/nail and then a second position of the hand/nail at a later time. If the distance between the first and second position exceeds a threshold then the system determines that the hand/nail has moved. Alternatively, a first image of the target location at a first time can be compared to a second image at a second time and if a comparison of pixels indicates movement of the hand/nail above a threshold then the system determines that the hand/nail has moved.

An example of a robotic system for painting nails is provided in U.S. Pat. No. 10,939,738, which is incorporated by reference in its entirety.

### Autoblotter

One of the systems included in this disclosure is a system for blotting nail polish, referred to here as an autoblotter. The autoblotter deals with the management of dispensed nail polish or other material. In some embodiments, the precise flow of the dispensed polish can be difficult to turn on and off due to the working mechanism of the polish containing cartridge. Polish only flows from the cartridge tip when sufficient pressure is applied appropriately, such as to the rear of the stopper at the back of the cartridge. Due to the unpredictability of the start of the actual flow of polish, the robotic apparatus for automatic nail polish application may in some cases benefit from a place to initially purge or blot some of the polish from the tip of the cartridge. This same location can be used to collect any unused polish at the end of the nail painting routine when the dispenser is turned off. This can be accomplished by blotting onto a blotting material (for e.g., paper strips), which are removed from the system at a regular interval or onto a mechanized platform that does not require the same level of maintenance, such as restocking the paper.

In some embodiments, an autoblotter may include a platform and an automated blotting surface. The platform may be located adjacent to a robotic dispenser of a robotic apparatus for automatic nail polish application. For example, the platform may be within a housing of a robotic nail system with the dispenser such that the dispenser can be moved to the surface to allow for the blotting function. The platform may be immediately adjacent the dispenser, such is directly under where the tip of the dispenser is positioned or directly under or next to where the nail to be polished is positioned. The robotic dispenser can be configured for dispensing nail polish. The placement of the platform ensures optimal access for the dispenser to perform its tasks efficiently. The platform could also serve as a stable base that supports the blotting surface and possibly other related components, such as the robotic dispenser itself or other accessories needed in the manicure process.

The automated blotting surface may be positioned on the platform and aims to receive any discharge of the dispensed nail polish from the robotic dispenser. For example, the blotting surface is designed to effectively capture and hold the excess or mis-dispensed nail polish, helping to maintain cleanliness, and potentially improving the precision of the polish application process.

The blotting surface may provide a space for the robotic dispenser to initially discharge or purge some nail polish from the cartridge. Despite the pressurized nature of the cartridge, starting the flow of polish can be unpredictable, frequently leading to an initial burst or overspray. By directing this initial discharge onto the blotting surface, the system can ensure a more controlled and predictable application of polish once it is applied to the nail.

The blotting surface may be used during the nail polishing process to blot or remove any excess nail polish from the dispenser tip where needed. For example, it may be used for blotting in between the painting of each nail.

After the nail painting routine, there may still be some nail polish left in the dispenser. Instead of allowing this surplus polish to potentially dry and clog the system, it can be discharged onto the blotting surface. In doing so, it helps keep the dispenser clean and ready for the next use.

The blotting surface may also provide options for different ways of managing captured excess polish, whether via removable paper strips or a mechanized or automated surface. For example, the paper strips would be single-use and disposed of after saturation, but would require regular restocking. In contrast, the automated surface may require less frequent maintenance, possibly being self-cleaning or easily cleanable.

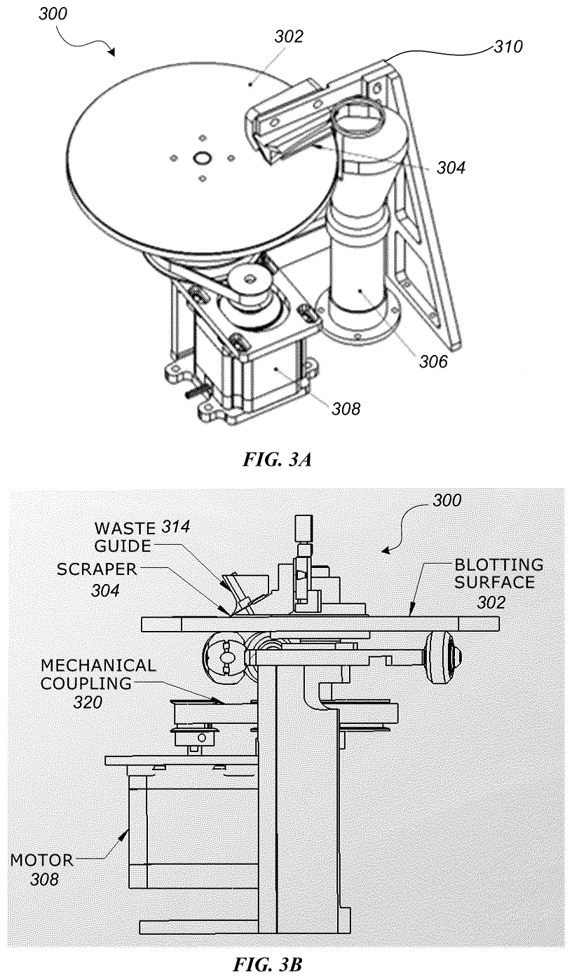

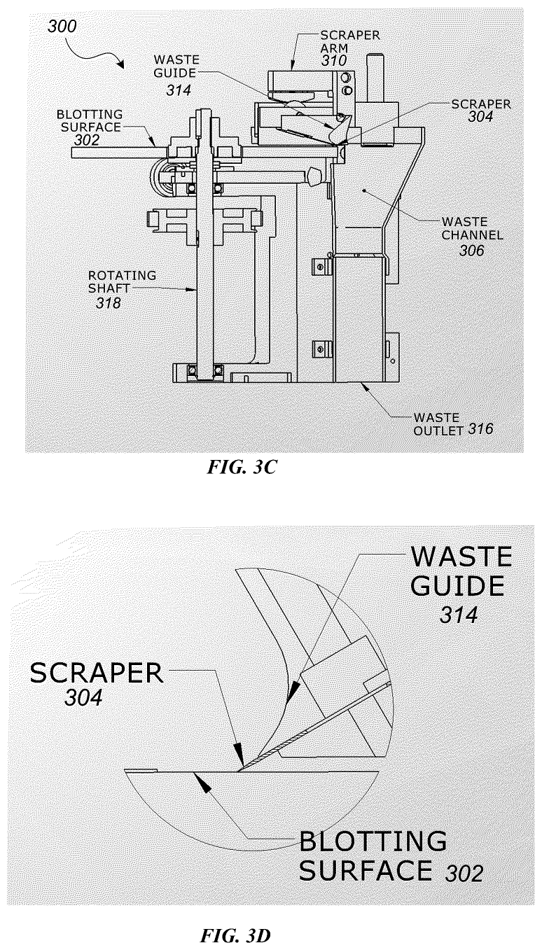

In some embodiments, the automated blotting surface is movable or rotatable to prevent oversaturation or buildup in a first area of the blotting surface. When the surface moves or rotates, the nail polish is spread across different areas, effectively distributing the material and preventing it from piling up. This aspect prevents any single area from becoming oversaturated, which can allow for longer usage periods before the blotting surface requires replacement or cleaning. The rotation or movement of the blotting surface ensures the entire surface area gets utilized over time, rather than concentrating the polish in one spot. The larger the surface area used, the more polish that can be accommodated during multiple polish dispensing cycles. The blotting surface is shown in FIGS. 3A-D as a disk, but it can take other forms, such as a conveyer belt that moves under the scraper and travels under and back around to allow for continuous scraping.

In some embodiments, the automated blotting surface is removable such that the blotting surface can be detached from the platform. By providing a removable blotting surface, users can easily detach it for a thorough clean-up or maintenance check without having to manipulate the whole autoblotter system. It allows a focus on cleaning the surface where nail polish actually accumulates, improving system hygiene and performance.

In some embodiments, the automated blotting surface includes a layered structure where once a top layer is covered with nail polish, it is peelable to reveal a clean layer beneath. Due to its multi-layered structure, this embodiment of blotting surface may provide an extended usage duration. As the top layer becomes saturated with nail polish, it can simply be peeled away to reveal a clean layer below, ready to be used. The peelable feature also makes maintenance simple and quick. The peeling of each layer may be automated. For example, an arm may contact the peelable surface to slide the layer off of the stack, or a pincher may grab the top layer and pinch both sides to pull it from the stack, or other automated peeling mechanisms.

In some embodiments, the automated blotting surface includes a continuous roll of material. The roll of blotting material may be set up in a holder or compartment within the autoblotter platform. For example, the roll of blotting material may be set on a cylindrical rod. A motor could be coupled with this rod and, when it's time to roll out fresh blotting material, the motor is operated to rotate the rod, causing the roll to turn and release more material on the blotting surface. Since the blotting surface is a continuous roll, it may yield a significant amount of material for blotting. This allows for extended use before the roll requires replacement, lending to efficiency in scenarios with high frequency or volume of nail polish applications. Rather than changing individual layers or cleaning the surface manually, the autoblotter may simply roll out fresh blotting material on the surface as needed, saving both time and effort. With the rotation of fresh blotting material, this prevents the buildup of nail polish in one spot.

In one embodiment, the autoblotter 300 includes a blotting surface 302, a scraper 304, and a waste channel conduit (or trash chute) 306 as shown in FIGS. 3A-D. The blotting surface 302 is rotatable around a central axis. The blotting surface 302 is configured to collect nail polish dispensed thereto. The blotting surface may be a disk, but may also be any other shape, such as a square, a rectangle, a triangle, etc. It may be a smooth or textured surface, or an irregular surface with bumps, or ridges. The blotting surface may include a non-porous material that enables removal of nail polish from the blotting surface. The non-porous material may be glass, metal, ceramic, silicone, plastic, or other materials, or a combination of one or more of these materials. The blotting material may also be a porous materials, such as a paper or fabric.

The scraper 304 may be adjacent to the blotting surface to remove nail polish thereon. As shown in FIGS. 3A-C, the scraper is attached to an arm 310 extendable over the blotting surface 302. The arm of the scraper may include a rigid material. The scraper may be attached to an underside of the arm and positioned above and in contact with the blotting surface for scraping off nail polish from the blotting surface. The scraper may include a blade or a surface with an edge that rests on or immediately above the blotting surface, such that when the blotting surface moves past the scraper, any material on the blotting surface comes into contact with the blade and is caught by the blade to scrape the material off or loose from the blotting surface. The scraper may be adjustable in position or angle relative to the blotting surface to enable removal of nail polish from the blotting surface. For example, it may be adjusted differently for different types of blotting surface, e.g., paper versus glass surfaces. It may be adjusted so that the edge or blade is closer or farther from the surface. The angle in which the scraper is positioned can also be adjusted. In some embodiments, the scraper can be moved or folded upward to access the underside of the scraper for cleaning material off of the scraper.

The scraper 304 may include a waste guide 314. The waster guide 314 may be positioned on a top portion of the scraper 304. The waste guide 314 may collect the nail polish removed by the scraper. After collecting the nail polish waste, the waste guide 314 may direct it towards the waste channel conduit 306.

The waste channel conduit 306 is adjacent to the scraper for collecting nail polish scraped off by the scraper and for directing the scraped nail polish to a waste collection area. The waste channel conduit may include a groove adjacent to the blotting surface for directing the scraped nail polish towards the waste collection area. The waste channel conduit may use centrifugal force generated by the rotating blotting surface to move the scrapings towards the waste collection area. The waste channel conduit can have any shape, including the shape shown in FIGS. 3A-C. For example, the waste channel conduit may be an elongated tube into which the nail polish scrapings enter. The nail polish scrapings may travel down the waste channel conduit 306 to the waste outlet 316. The groove may be in contact with or immediately adjacent the blotting surface so that nail polish scrapings are caught in the groove when the blotting surface is moved.

The autoblotter may include a motor 308 mechanically linked to the blotting surface 302 through a mechanical coupling 320 and configured to facilitate rotation of the blotting surface. The motor may be configured to regulate speed of the rotatable blotting surface. The autoblotter may be housed within or adjacent to a robotic apparatus for automatic nail polish application. For example, the autoblotter may be mounted on a platform located adjacent to a robotic dispenser of the robotic apparatus.

In some embodiments, the tip of the robotic dispenser may make contact with the blotting surface following a predefined pattern. This pattern could range from tiny specks to lines or pools of nail polish dispersed across various sections of the blotting surface. As the robotic dispenser continues its operation, diverse areas of the blotting surface may exhibit an array of nail polish dots.

To explain in more detail the operation of the autoblotter, the blotting surface serves to gather nail polish dots or blots, and transports them to an area designated for removal by a scraper. As explained above, the scraper can feature a rigid blade for effective cleaning/scraping of the blotting surface. Affixed to an extending arm over the blotting surface, the scraper blade may be positioned either in direct contact with or just above the blotting surface.

The motor 308 may be attached to a rotating shaft 318 linked to the blotting surface 302 via a belt and/or a set of pulleys to provide rotation of the blotting surface 302. The calculated slow spin of the blotting surface may allow time for nail polish drops to air dry, aiding their removal by the scraper without leaving residual traces. As the blotting surface rotates, the deposited nail polish dots glide under the scraper, which removes them. The scraped off polish accumulates in front of the scraper for disposal

Once a quantity of nail polish has been cleared by the scraper blade, the resulting mass of scraped material is slowly propelled outward towards a waste channel conduit or similar trash receptacle due to the centrifugal force elicited by the rotating blotting surface. The waste channel conduit may be an elongated tube with an opening located either on top or adjacent to the blotting surface. The waste channel conduit may be designed to receive the waste material composed of scraped-off nail polish. The lower opening of the conduit may deposit the waste material to a designated waste locale. In some embodiments, either a guiding groove on the blotting surface or an elevated guiding structure may be implemented to steer the waste material towards the waste channel conduit. Alternatively, an arm equipped with a guide may be used to direct the waste material towards the conduit. After the mass of dried polish descends through the waste channel conduit, it joins other waste at the outlet of the conduit. In some instances, the waste channel outlet may directly lead to a trash can or other forms of receptacles for waste collection and subsequent disposal.

The autoblotter may be a part of the robotic apparatus for automatic nail polish application, and may be inside the housing of the robotic apparatus. The autoblotter may also be a separate system designed to allow blotting of a nail polish dispenser or any other material dispenser. A user may also manually blot nail polish onto an autoblotter when it is a standalone system, and the scraper may maintain the clean blotting surface by scraping the polish and collecting the remnants into a trash chute or other trash collecting device.

An automated method of cleaning a blotting surface of an autoblotter may include identifying when an area of the blotting surface contains nail polish and engaging the area of the blotting surface with a cleaning tool to remove the nail polish. For example, this identification may be achieved through various mechanisms, such as visual inspection or sensor-based measurements.

Upon successful identification of nail polish on the blotting surface, the blotting surface may be caused to engage a cleaning tool to interact with the identified area. The cleaning tool may be a scraper or another similar device. The cleaning tool may be configured to remove the nail polish from the blotting surface thoroughly. The engagement of this tool with the blotting surface may involve movement or positioning adjustments, with the tool aligning optimally to scrape off or clean the nail polish. This process may be programmed to repeat as necessary, driven by the ongoing detection of nail polish on the blotting surface, ensuring maintained cleanliness and readiness for subsequent operations.

The method may also include actuating the blotting surface to move the blotting surface area that contains nail polish under the scraper to scrape off the nail polish. This process may be initiated by activating a mechanism that moves the blotting surface. For example, this can be accomplished by activating the scraper to engage with the nail polish on the blotting surface, collecting scraped nail polish with a waste guide positioned on top of the scraper and directing the collected nail polish towards a waste collection area. The method may also include directing the removed nail polish towards a waste collection area.

The autoblotter may employ the waste guide, strategically positioned on top of the scraper, to collect the scraped off nail polish. The waste guide operates as a mover, directing the collected nail polish towards a predetermined waste collection area. This sequence ensures that the cleaned-off nail polish is swiftly and efficiently moved away from the blotting surface, maintaining the cleanliness and operational readiness of the autoblotter.

### Automatic Nail Polish Remover

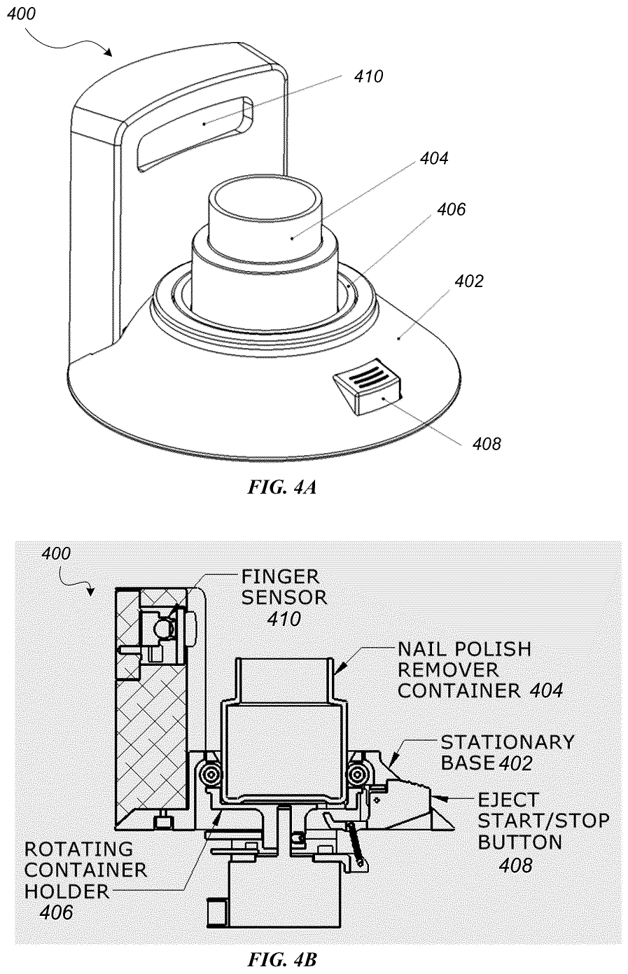

As shown in FIGS. 4A-B, an automatic nail polish remover system 400 include a stationary base 402, a nail polish remover container (or pot) 404 and a rotating container holder 406.

The stationary base 402 serves as the foundational component of the system 400. It may include a flared bottom to provide better stability and prevent tipping over. The flared bottom base may be a design choice that helps to provide better stability to the system 400. This may prevent the system from tipping over, ensuring safe and smooth operation. The stationary base is also designed to house the nail polish remover container 404 or pot. The rotating container holder 406 is positioned rotatably on the stationary base 402.

The nail polish remover container 404 may be positioned within the stationary base 402. It may serve as a reservoir for both a nail polish removing material and a solvent. The polish remover container 404 may be configured to contain a material for assisting in the removal of nail polish. In some embodiments, the material may include a wiping material that is soaked with a solvent. The wiping material may be foam, sponge, cotton, or other material or combination of materials used to remove polish from nails. The solvent may be acetone, ethyl acetate, butyl acetate, isopropyl alcohol, propylene carbonate or methyl ethyl ketone, or other materials or a combination of materials. When the soaked wiping material comes into contact with nail polish, the solvent in the material may dissolve the nail polish.

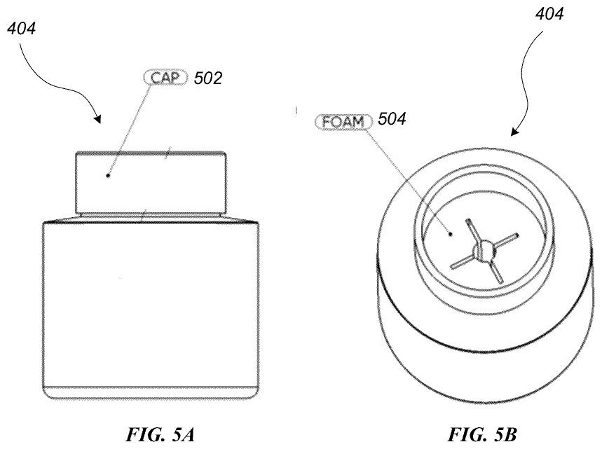

Exemplary embodiments of the nail polish remover container 404 are shown in FIGS. 5A-B. In FIG. 5A, the nail polish remover container 404 has a cap 502. The cap 502 may be removed before the container 404 is positioned inside the rotating container holder 406. In FIG. 5B, foam 504 is provided inside the container 404.

In some embodiments, the material for assisting in the removal of nail polish may include an abrasive material that includes particles. When the abrasive material comes into contact with nail polish, the abrasive material physically scrubs or wears away layers of the nail polish. The abrasive material may include emery board, pumice stone, or silicon carbide abrasive paper, or other material for abrading the surface of the polish.

The rotating container holder 406 may be rotatably positioned on the stationary base. This secures the nail polish remover container within the stationary base and allows rotation of the nail polish remover container by the rotating container holder during use. The rotating container holder 406 may include a cavity designed to receive the nail polish remover container and providing secure placement of the nail polish remover container to prevent tipping or spilling. The container may also be designed to move in other manners besides or in addition to rotation. For example, it may move up and down or side-to-side in the holder to assist in removing the polish. A mechanical base underneath the container can be moved with a lever or other system to move the container up and down, and similarly cause movement from side-to-side.

In some embodiments, the system 400 may include a stop/start button located on the stationary base 402 for stopping or starting the rotation process. For example, a user may press the stop/start button to stop or activate rotation of the rotating container holder. In some embodiments, the insertion of the user's finger into the container may cause the automatic starting of the rotation, and the removal of the finder may cause the automatic stopping of the rotation.

The automatic nail polish remover system 400 may include an ejection mechanism (e.g., button) 408 for releasing the nail polish remover container from the stationary base. In some embodiments, the ejection mechanism may be a physical button located on the stationary base 402. When the button is pressed, it triggers a mechanical action, such as a spring-loaded release, that pushes the nail polish remover container 404 out of its position in the rotating container holder 406, enabling easy extraction from the base. In some embodiments, the ejection mechanism may be a lever. When the lever is pushed down or pulled up, it would create a movement that dislodges or lifts the nail polish remover container 404 for removal. In some embodiments, the ejection mechanism may be a slide or switch. When shifted in one direction, it may create a simple mechanical motion that ejects the nail polish remover container 404.

The system may further include a sensor (or detector) 410 adjacent the nail polish remover container 404 for detecting a user's finger adjacent to the nail polish remover container and for activating rotation of the rotating container holder to rotate the nail polish remover container around the user's finger to remove the nail polish. In some embodiments, the sensor 410 may be a proximity sensor that can detect when a user's finger is close to or inside the nail polish remover container 404. As an example, this sensor may emit an electromagnetic or ultrasonic field, then may look for changes in the field. When a finger, which disrupts the field, is inserted into or near the container, this disruption is detected, signaling the system to activate the rotating container holder 406. The sensor may be positioned as shown in FIGS. 4A-B on a wall or projection attached to the base or near the base, which extends from the base upward such that the sensor is positioned just above and near the opening of the container. In other embodiments, the sensor may be positioned inside the container on wall of the container or on the bottom of the container. The sensor could also be positioned right at the opening of the container or on the base.

In operation, a user may start the process by placing their finger into the nail polish remover container 404 filled with a material soaked in a solvent. Once the finger is detected by the sensor 410, or the start button is pressed, the rotating container holder 406 may start to rotate the nail polish remover container 404. As the container rotates, the user's finger and particularly the nail may make continual contact with the material and/or solvent. The entire surface of the nail may come into contact with the material and/or solvent, ensuring a thorough cleaning.

The material and/or solvent may interact chemically with the nail polish, causing it to dissolve. Once the nail polish has been removed, the user may remove their finger from the nail polish remover container 404. The system may be deactivated by moving the finger away from the sensor 410, manually with a stop button, or automatically through an in-built timer.

### Nail Polish Cartridge and Cap

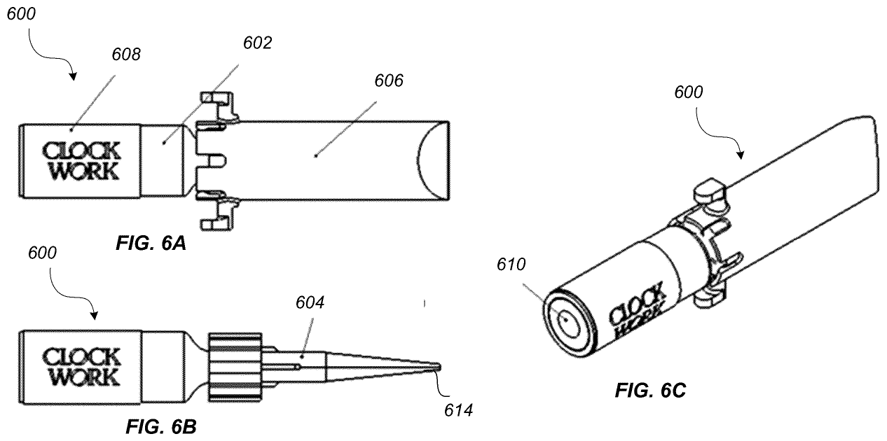

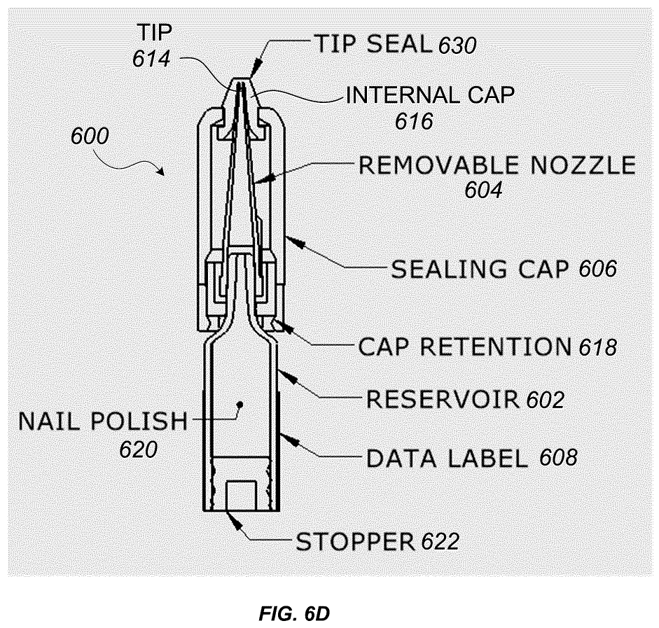

As shown in FIGS. 6A-D, a cartridge 600 include a reservoir 602, a nozzle 604, a sealing cap 606 and an electronic storage device 608. The reservoir 602 is configured to hold nail polish 620. The reservoir may include a body having a first end and a second end of a chamber that stores the nail polish. The cartridge 600 may also include a rear seal 610 that seals the rear of the reservoir. The reservoir may be resistant to potential chemical reactions with the polish constituents to maintain the polish's integrity. It may also be rigid enough to withstand external pressures while being flexible enough to allow the polish to be propelled out when a force is applied. The reservoir may be cylindrically shaped, allowing for an efficient use of space and easy dispensation of the polish. The size of the reservoir can vary depending on the intended single-use quantity of the nail polish. The nail polish within the reservoir 602 may be prevented from backflow or leakage by a rear seal 610. This seal may be useful in maintaining the longevity and usability of the polish since it may prevent unwanted exposure to air, which can deteriorate the polish.

A stopper 622 may be positioned inside the reservoir to propel the nail polish out of the nozzle when a force is applied. This action may allow the nail polish to be dispensed in a controlled manner, reducing the likelihood of wastage or spillage. The stopper may be from a rubber material, which has properties to withstand the chemical composition of the nail polish. The stopper material may be resistant to the chemical constituents of the polish to prevent degradation over time, which may potentially contaminate the polish or alter its properties. In some embodiments, rubber may be used as a stopper because of its impermeability to gases and resistance to various chemicals, heat, and aging. Aside from resistance to the polish chemicals, the stopper may also be flexible enough to move within the reservoir and hardy enough to withstand repeated force application

The nozzle 604 may be designed to be releasably coupled to the reservoir 602, which means that it can be attached and detached as needed. This feature may allow for easy assembly, replacement, or cleaning of the nozzle, adding to the convenience of using the cartridge. The nozzle may be designed with a shape and size that allows for controlled and smooth dispensing of nail polish. The nozzle design may ensure that the right amount of polish is dispensed, contributing to a cleaner and more satisfying application. The nozzle may have a tapered tip or a precision molded orifice that lets it direct the polish precisely onto the nail surface. This way, the polish application may be efficient and reduce the chances of spillage or wastage. The nozzles may be made of materials that are resistant to the nail polish's chemical properties to avoid corrosion or wear and tear over time. This may provide longevity, safety, and consistent performance of the cartridge.

The sealing cap 606 may be removably mounted on the nozzle for sealing the nozzle. It may prevent air from entering the cartridge and prevent the evaporation of volatile components in the nail polish. The sealing cap 606 can be mounted onto the nozzle 604. The cap may have an open end that fits over the nozzle and a closed end opposite the open end. The closed end may be tapered on one or both sides. It may be designed to fit snugly and securely to create a firm seal, preventing any leakage of the nail polish when not in use. The sealing cap 606 may also include a cap retention feature 618, such as tabs or support pins along the cap at its open end, allowing the cartridge to be hung and serving an operational or display function. This may make it easy for customers to pick their chosen color or finish. The tabs or support pins may project outward from the open end of the cap, and then curve downward to create a ledge or hook that may sit on a surface or sit over and around a rail to hold the cartridge in a hanging position. There may be one or more support pins or tabs. There may also be one or more slots or grooves along the open end of the cap near the support pins or tabs.

An internal cap 616 may be positioned inside of the sealing cap 606 at the closed end of the sealing cap 606. The internal cap 616 may be in sealing contact against the tip 614 of the nozzle 604 when the sealing cap 606 covers the tip 614 of the nozzle 604, such that the internal cap 616 and the sealing cap 606 create a double cap structure to ensure preservation of the polish's integrity. The internal cap may create an additional tip seal 630 on the nozzle, specifically against the tip 614 of the nozzle 604. When the outer sealing cap covers the nozzle's tip, the internal cap may reinforce the sealing, thereby providing an extra layer of security. This redundancy may ensure that even in the event that the outer cap does not completely seal the nozzle, the inner cap provides the backup necessary to avoid polish exposure to air.

The electronic storage device 608 may be a data label include a radio frequency identification (RFID) chip, a near field communication (NFC) chip, or other forms of wireless communication devices. For example, the label may hold information about the cartridge contents, such as color, composition, or even a specific batch number for identification and tracking purposes. This can help in selecting the correct polish based on customer preference or pre-set modes. By applying RFID or NFC technology, the data label may directly communicate with other devices, like a robotic apparatus for automatic nail polish application. This can enable automated functions such as selecting, dispensing, and applying the correct polish, thus enhancing the efficiency and precision of operations. Data labels may allow for interactive functionalities. For instance, a user may touch their smartphone to the NFC-enabled labels to access additional product information, promotional content, or to confirm product authenticity. Usage data stored on these labels may be uploaded and analyzed to gain insights on user behavior, cartridge usage, or to maintain inventory. This data could subsequently guide product development, inventory management, and other business decisions.

### Cartridge Dispenser

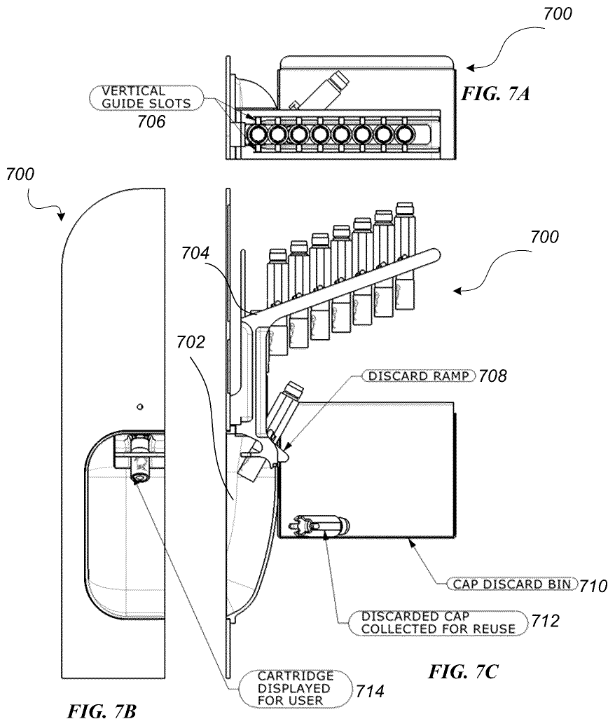

As shown in FIGS. 7A-C, a cartridge dispenser 700 may include a display area 702, an inclined feed rail 704, a pair of vertical guide slots 706 and a discard ramp 708. The display area is configured for displaying cartridges. The display area is the part of the cartridge dispenser where the cartridges are showcased. This area is designed to allow users to easily view and identify the cartridges. The display area may be designed to not only showcase the cartridges but also provide easy access for cartridge extraction. It may feature an inclined surface, which allows the cartridges to tilt towards the user. The inclination angle may be carefully optimized to balance the visibility of the cartridge and the ease of grasping and pulling out the cartridge by the user. In some embodiments, the rail is not inclined and the cartridges are moved via a mechanical system to push the cartridges along the rail, or moved manually by a user.

The inclined feed rail 704 may be adjacent the display area. The inclined feed rail may be adapted for holding the cartridges arranged along the inclined feed rail, each cartridge comprising a seal. The inclined feed rail may hold the cartridges in an orderly arrangement. Each cartridge, along with its sealing cap, may be lined up neatly along the rail. The inclined feed rail may be placed next to the display area. This strategic positioning enables efficient movement of cartridges from the rail to the display area. The cartridge dispenser may be included as part of a robotic apparatus that uses the cartridges with a robotic dispenser for automatically applying polish to a user's nails.

The inclined feed rail may interact with a pair of vertical guide slots. The slots may work with the sealing cap's support pins to secure the cartridge on the feed rail and control its descent into the display area. The rail's inclination may serve dual purposes. First, it may help present the cartridges to the user in a noticeable manner. Secondly, it may take advantage of gravity to feed the cartridges forward into the display area chart and promotes efficient cartridge transition when one is removed.

A pair of vertical guide slots may be coupled to the feed rail for controlling an orientation and path of the cartridges as they descend from the feed rail into the display area. The vertical guide slots may be responsible for directing the orientation and path of the cartridges as they descend from the inclined feed rail into the display area. They may facilitate the smooth falling of the cartridges into the display area in a controlled manner. The sealing cap of each cartridge may interact with the vertical guide slots. The sealing cap of each cartridge may rest on the vertical guide slots. The sealing cap may rest on these slots, which helps in holding the cartridges in place on the inclined feed rail. The slots may also contribute to the smooth movement of the cartridge when the user pulls the cartridge out. The vertical guide slots may be coupled to the feed rail, making them an integral part of the cartridge movement mechanism. This coupling may ensure a seamless transition of the cartridges along the entire pathway from the feed rail to the display area. As the cartridge is pulled out by a user, the support pins on the sealing cap may prevent motion. The guide slots' design may ensure that the sealing cap remains in place while the cartridge is being retrieved, facilitating easy separation.

A discard ramp 708 may be positioned below the display area for collecting sealing caps removed from the cartridges. When a cartridge is pulled out from the display area, the sealing cap of the cartridge rotates away from the display area and falls onto the discard ramp. The discard ramp 708 may be positioned below the display area to neatly collect the sealing caps 712 once they are detached from the cartridges. As a cartridge is pulled out from the display area by a user, the sealing cap, held in place by the support pins, may get separated from the cartridge body. The cap may rotate away from the display area and falls onto the discard ramp. The discard ramp may operate on the principle of gravity, guiding the sealing caps into a discard bin 710 or a trash receptacle. This may ensure an orderly collection of the caps without causing any mess or obstruction in the display area. For example, the caps may slide down the ramp, minimizing any possibility of a cap getting stuck at the feeder.

The cartridge dispenser may include an inclined surface within the display area for seating support pins of the sealing cap of each of the cartridges 714, allowing the cartridge 714 to tilt forward for easy access. The inclined surface may be located within the display area of the cartridge dispenser. It may be designed to seat the support pins of the sealing cap attached to each cartridge. By seating the sealing cap's support pins, the inclined surface may allow the cartridge to tilt forward toward the user. This forward tilt may make it convenient for the user to view and physically access the desired cartridge. When a user pulls the cartridge downward, the pins, due to their design and location, may stay in place, thus causing the sealing cap to dynamically disengage from the cartridge as it is pulled out by the user.

The support pins of the sealing cap of the cartridge may be configured to prevent motion of the sealing cap when the cartridge is pulled out by a user to enable the sealing cap to separate from the cartridge. The function of the support pins may be to secure the cartridge in place on the dispenser's inclined feed rail, collaborating with the vertical guide slots. When a user pulls a cartridge from the display area, the support pins on the sealing cap may remain static. Their configuration may lock the cap in place, allowing the cartridge to move while the sealing cap remains static. As a user draws out a cartridge, the locked position of the sealing cap due to the support pins may facilitate the cap's separation from the cartridge. This mechanism may allow for smooth, effortless removal of the cartridge from the display area without the cap attached.

The cartridge dispenser may include a guide adjacent to the feed rail for allowing a next available cartridge to automatically fall into the display area once a previous cartridge has been removed therefrom. The guide may allow the next available cartridge to fall into the display area automatically once a previous cartridge has been removed. The guide may work in conjunction with the inclined feed rail to keep cartridges flowing smoothly into the display area. As cartridges are removed, the inclination of the feed rail encourages the next cartridge to move down towards the guide. The guide may ensure a seamless and user-friendly transition of cartridges, maintaining a constant provision of cartridges in the display area for users.

In some embodiments, a cartridge may include: a body having a first end, a second end, and a chamber formed between the first end and the second end for containing nail polish; a tip coupled to the first end of body and configured to direct flow of nail polish onto a nail surface; a rear seal coupled to the second end of the body to provide sealing thereto; and a removable sealing cap having an open end and a closed end, the removable sealing cap for covering the tip to close the tip of the cartridge, the sealing cap including one or more support pins adjacent the open end.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of embodiments. This description should be read to include one or at least one and the singular also includes the plural unless it is obvious that it is meant otherwise. The use of the term and/or is intended to mean any of: “both”, “and”, or “or.”

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments.

What is claimed is:

1. An autoblotter comprising:
a blotting surface or test area designed to receive a discharge of dispensed nail polish from a robotic dispenser.

2. The autoblotter of claim 1, wherein the blotting surface is movable or rotatable to prevent oversaturation or buildup in a first area of the blotting surface, and wherein the autoblotter further comprises a platform located adjacent to a robotic dispenser that is configured for dispensing nail polish, the blotting surface or test area positioned on the platform.

3. The autoblotter of claim 1, wherein the blotting surface is removable such that the blotting surface can be detached from a nail service robot.

4. The autoblotter of claim 1, wherein the blotting surface comprises a layered structure where, once a top layer of the layered structure is covered with nail polish, the top layer is peelable to reveal a clean layer beneath.

5. The autoblotter of claim 1, wherein the blotting surface comprises a continuous roll of material.

6. An autoblotter comprising:
a blotting surface rotatable around a central axis, the surface being configured to collect nail polish dispensed thereto;
a scraper adjacent to the blotting surface to remove nail polish thereon; and
a waste channel conduit adjacent to the scraper for collecting nail polish scraped off by the scraper and for directing the scraped nail polish to a waste collection area.

7. The autoblotter of claim 6, further comprising a motor mechanically linked to the blotting surface and configured to facilitate rotation of the blotting surface.

8. The autoblotter of claim 7, wherein the drive motor is configured to regulate speed of the rotatable blotting surface.

9. The autoblotter of claim 6, wherein the blotting surface comprises a disk.

10. The autoblotter of claim 6, wherein the blotting surface comprises a non-porous material that enables removal of nail polish from the blotting surface.

11. The autoblotter of claim 10, wherein the non-porous material comprises any one of: glass, metal, ceramic, silicone and plastic.

12. The autoblotter of claim 6, wherein the scraper is attached to an arm extendable over the blotting surface.

13. The autoblotter of claim 12, wherein the arm of the scraper comprises a rigid material, the scraper attached to an underside of the arm and positioned above and in contact with the blotting surface for scraping off nail polish from the blotting surface.

14. The autoblotter of claim 6, wherein the scraper is adjustable in position or angle relative to the blotting surface to enable removal of nail polish from the blotting surface.

15. The autoblotter of claim 6, wherein the waste channel conduit comprises a groove adjacent to the blotting surface for directing the scraped nail polish towards the waste collection area.

16. The autoblotter of claim 15, wherein the waste channel conduit uses centrifugal force generated by the rotating blotting surface to move the scrapings towards the waste collection area.

17. The autoblotter of claim 6, wherein the autoblotter is housed within or adjacent to a robotic nail treatment system.

18. A method of cleaning a blotting surface of an autoblotter, comprising:
identifying when an area of the blotting surface contains nail polish; and
engaging the area of the blotting surface with a cleaning tool to remove the nail polish.

19. The method of claim 18, further comprising:
directing the removed nail polish towards a waste collection area.

20. The method of claim 18, wherein engaging the area of the blotting surface with the automated cleaning tool to remove the nail polish comprises:
actuating the blotting surface to move the blotting surface area that contains nail polish under the scraper to scrape off the nail polish.

21. The method of claim 18, wherein actuating the blotting surface to move the blotting surface area that contains nail polish under the scraper to scrape off the nail polish comprises:
activating the scraper to engage with the nail polish on the blotting surface;
collecting scraped nail polish with a waste guide positioned on top of the scraper; and
directing the collected nail polish towards a waste collection area.

22. A system comprising:
a stationary holder;
a nail polish remover container positioned within the stationary holder, wherein the nail polish remover container is configured to contain a material for assisting in the removal of nail polish; and
a rotating container holder rotatably positioned on the stationary holder for securing the nail polish remover container to the stationary holder and rotating the nail polish remover container during use.

23. The system of claim 22, further comprising an ejection mechanism for releasing the nail polish remover container from the stationary holder.

24. The system of claim 22, wherein the stationary holder is a base comprising a flared bottom to provide better stability and prevent tipping over.

25. The system of claim 22, wherein the rotating container holder comprises a cavity designed to receive the nail polish remover container and providing secure placement of the nail polish remover container to prevent tipping or spilling.

26. The system of claim 22, wherein the material for assisting in the removal of nail polish comprise a wiping material that is soaked with a solvent such that, when the soaked wiping material comes into contact with nail polish, the solvent in the material dissolves the nail polish.

27. The system of claim 22, wherein the material for assisting in the removal of nail polish comprises an abrasive material that includes particles such that, when the abrasive material comes into contact with nail polish, the abrasive material physically scrubs or wears away layers of the nail polish.

28. The system of claim 27, wherein the abrasive material comprises any one of: emery board, pumice stone and silicon carbide abrasive paper.

29. The system of claim 22, further comprising a sensor adjacent the nail polish remover container for detecting a user's finger adjacent to the nail polish remover container and for activating rotation of the rotating container holder to rotate the nail polish remover container around the user's finger to remove the nail polish.

30. A cartridge comprising:
a reservoir for holding nail polish;
a nozzle coupled to the reservoir for dispensing the nail polish;
a removable sealing cap for sealing the nozzle; and
an electronic storage device.

31. The cartridge of claim 30, further comprising a rear seal.

32. The cartridge of claim 30, further comprising a stopper positioned inside the reservoir to propel the nail polish out of the nozzle when a force is applied.

33. The cartridge of claim 30, wherein the stopper is made of a rubber material suitable for withstanding a chemical composition of nail polish.

34. The cartridge of claim 30, further comprising an internal cap positioned inside of the sealing cap and in sealing contact against a tip of the nozzle when the sealing cap covers the tip of the nozzle, such that the internal cap and the sealing cap create a double cap structure to ensure preservation of the polish's integrity.

35. A cartridge dispenser, comprising:
a display area for displaying cartridges;
an inclined feed rail adjacent the display area for holding the cartridges arranged along the inclined feed rail, each cartridge comprising a sealing cap;
a pair of vertical guide slots coupled to the feed rail for controlling an orientation and path of the cartridges as they descend from the feed rail into the display area, the sealing cap of each cartridge resting on the vertical guide slots to hold the cartridge on the inclined feed rail; and
a discard ramp positioned below the display area for collecting sealing caps removed from the cartridges,
wherein, when a cartridge is pulled out from the display area, the sealing cap of the cartridge rotates away from the display area and falls onto the discard ramp.

36. The cartridge dispenser of claim 35, further comprising an inclined surface within the display area for seating support pins of the sealing cap of each of the cartridges, allowing the cartridge to tilt forward for easy access.

37. The cartridge dispenser of claim 36, wherein the support pins of the sealing cap of the cartridge are configured to prevent motion of the sealing cap when the cartridge is pulled out by a user to enable the sealing cap to separate from the cartridge.

38. The cartridge dispenser of claim 35, further comprising a guide adjacent to the feed rail for allowing a next available cartridge to automatically fall into the display area once a previous cartridge has been removed therefrom.
